(19) United States
(12) Patent Application Publication
(10) Pub. No.: US 2025/0383036 A1
(43) Pub. Date: Dec. 18, 2025

(54) FLOAT

(71) Applicant: Eddy Pump Corporation, El Cajon, CA (US)

(72) Inventor: Daniel WAHLGREN, Escondido, CA (US)

(21) Appl. No.: 19/181,456

(22) Filed: Apr. 17, 2025

Related U.S. Application Data
(60) Provisional application No. 63/636,618, filed on Apr. 19, 2024.

(51) Int. Cl. F16L 11/133; F16L 57/02

(52) U.S. Cl. CPC F16L 11/133; F16L 57/02

(57) ABSTRACT

A float system includes a first float element and a second float element. The first float element is attachable to the conduit, and the second float element is attachable to the conduit adjacent the first float element. The first float element and the second float element are capable of restricting a bending angle of the conduit.

### CROSS REFERENCE TO RELATED APPLICATIONS

This application claims priority to U.S. Provisional Application Ser. No. 63/636,618, filed Apr. 19, 2024, the contents of which are hereby incorporated by reference.

### BACKGROUND

### Technical Field

The present disclosure relates to a float that can be a bend-limiting float configured to limit the bend radius of a conduit. In particular, the present disclosure relates to a float or float system that is configured to attach to a conduit to provide buoyancy to the conduit while preventing the conduit from bending beyond a prescribed bend radius.

### Background Information

Equipment such as harvesters and dredgers that are used to clean aquatic environments typically use a flexible hose to carry pumped material that has been removed from a work area. Floats are typically attached to the flexible hose to keep the hose on or near the surface of the water. This arrangement facilitates pumping efficiency and avoids entanglements of the hose with respect to objects under the surface of the water.

### SUMMARY

Conventionally, the floats attached to the flexible hoses of harvesters and dredgers have been large in size and spaced apart from each other by up to several feet. Such large-sized floats are effective at keeping the hose near the surface of the water. However, it has been determined that since these floats are spaced apart from one another, there is a tendency for the hose to become bent at a portion of the hose where the floats are not provided. Since the floats are spaced apart, there is substantially no limit on the degree to which the flexible hose can bend. If the hose bends beyond a certain bend radius, the resistance to the flow of material through the hose can increase and place an unnecessary burden on the pump. Also, air can be trapped inside the hose, making it difficult to prime the pump. The hose can also fold over on itself and become damaged. Additionally, since the hose is exposed between the floats, the hose can be vulnerable to damage caused by rocks and other objects both in the water and on land.

Therefore, it has been determined that there is a need for an improved float system that provides buoyancy, prevents the hose from bending beyond a predetermined amount and also protects the hose from damage. Furthermore, it has also been determined that limiting the bending radius of various types of conduits other than a hose is also desired. Accordingly, a first aspect of the present disclosure is to provide a float system that includes a first float element and a second float element. The first float element is configured to attach to the conduit, and the second float element is configured to attach to the conduit adjacent the first float element. The first float element and the second float element are configured to restrict a bending angle of the conduit.

A second aspect of the present disclosure is a float system according to the first aspect that further includes at least one fastener configured to fasten the first float element to the second float element.

A third aspect of the present disclosure is a float system according to any of the previous aspects, wherein when attached, the first float element and the second float element define a central opening, and the at least one fastener is configured to be capable of adjusting a size of the central opening by tightening and loosening the at least one fastener

A fourth aspect of the present disclosure is a float system according to any of the previous aspects, wherein the first float element is configured to define a first interior space, and the second float element is configured to define a second interior space.

A fifth aspect of the present disclosure is a float system according to any of the previous aspects, wherein the first interior space is filled with air and the second interior space is filled with air.

A sixth aspect of the present disclosure is a float system according to any of the previous aspects, wherein the first interior space is filled with a buoyant material and the second interior space is filled with the buoyant material.

A seventh aspect of the present disclosure is a float system according to any of the previous aspects, wherein the buoyant material is a foam plastic.

An eighth aspect of the present disclosure is a float system according to any of the previous aspects, wherein the first float element includes a first engagement surface that extends transverse to a longitudinal direction of the conduit, when the first float element is attached to the conduit, the first engagement surface configured to form an angle with a plane that is perpendicular to a longitudinal direction of the conduit.

A ninth aspect of the present disclosure is a float system for a conduit. The float system comprises a first float member configured to attach to the conduit, and a second float member configured to attach to the conduit adjacent the first float member. The first and second float members are configured to interact to prevent a reduction of flow through the conduit.

A tenth aspect of the present disclosure is a float system according to any of the previous aspects, wherein a portion of the first float member is configured to contact a portion of the second float member to prevent the reduction of flow through the conduit.

A tenth aspect of the present disclosure is a float system according to any of the previous aspects, wherein the float element has a central opening and an inner circumferential surface that are defined by the first float element and the second float element. The inner circumferential surface includes at least one flat portion.

An eleventh aspect of the present disclosure is a float system according to any of the previous aspects, wherein the first and second float members have adjustable connection surfaces.

A twelfth aspect of the present disclosure is a float system according to any of the previous aspects, wherein the first and second float members are configured to prevent a substantial reduction in an internal area of the conduit.

A thirteenth aspect of the present disclosure is a float system according to any of the previous aspects, wherein the first float member includes a first engagement surface that extends transverse to a longitudinal direction of the conduit, when the first float member is attached to the conduit, and the second float member includes a second engagement surface that extends transverse to the longitudinal direction of the conduit, when the second float member is attached to the conduit, the first and second engagement surfaces configured to be separate when the conduit is straight and configured to engage when the conduit is in a curved configuration.

A fourteenth aspect of the present disclosure is a float system for a conduit. The float system comprises a plurality of float members, each float of the plurality of float members including a first float element and a second float element, the first float element and the second float element being configured to be attached together. The plurality of float members are attachable to the conduit so as to be spaced apart by a prescribed distance and configured to limit bending of the conduit to a prescribed bend radius.

A fifteenth aspect of the present disclosure is a float system according to any of the previous aspects, wherein the plurality of float members includes a first float member and a second float member, and a portion of the first float member is configured to contact a portion of the second float member to limit bending of the conduit to the prescribed bend radius.

A sixteenth aspect of the present disclosure is a float system according to any of the previous aspects, wherein the first float member includes a first engagement surface that extends transverse to a longitudinal direction of the conduit, when the first float member is attached to the conduit, and the second float member includes a second engagement surface that extends transverse to the longitudinal direction of the conduit, when the second float member is attached to the conduit, the first and second engagement surfaces configured to be separate when the conduit is straight and configured to engage when the conduit is in a curved configuration.

A seventeenth aspect of the present disclosure is a float system according to any of the previous aspects, wherein each float member of the plurality of members has adjustable connection surfaces.

An eighteenth aspect of the present disclosure is a float system according to any of the previous aspects, wherein the plurality of float members are configured to prevent a substantial reduction in an internal area of the conduit.

A nineteenth aspect of the present disclosure is a float system according to any of the previous aspects, wherein the first float member is configured to interlock with the second float member.

A twentieth aspect of the present disclosure is a float system according to any of the previous aspects, wherein each of the first and second float members includes a first section and a second section, and the first and second float members being configured to connect together by having the second section of the first float member being accommodated within the first section of the second float member.

As will be described in more detail, embodiments of the present disclosure provide a simple light-weight structure that enables a flexible conduit to float on a water surface while preventing the conduit from bending excessively. This feature is particularly useful at portions of the conduit where the conduit is connected to a pump or other apparatus and can be prone to excessive bending. The float members also serve to protect the conduit from rocks and other objects onshore or in shallow water. In this way, expensive conduits, such as slurry hoses used with dredgers and harvesters, can be protected while enabling material to be pumped through the hose efficiently without flow restrictions. In addition to being used on flexible hoses carrying liquids or slurries, floats according to the present disclosure can also be used with electrical conduits, flexible tubes or hoses carrying gases or any other material, or any other tubular conduit that is at risk of bending beyond an acceptable bend radius. Moreover, since the float members are capable of being used in a float system that includes a plurality of float members arranged adjacent one another along the outer surface of the conduit, the float members can be used selectively along portions of the conduit where they are most needed. Thus, the float members can provide a cost-effective way to protect the conduit at the portions where protection is needed the most.

### BRIEF DESCRIPTION OF THE DRAWINGS

Embodiments of the invention will be explained in more detail hereinafter with reference to the drawings.

FIG. 1 illustrates a float system with a plurality of float members disposed on a conduit connected to a pump prior to being inserted into a fluid material or other material.

FIG. 2 illustrates the float system of FIG. 1 provides buoyancy to the conduit as the pump is being inserted into a fluid material.

FIG. 3 illustrates the float system of FIG. 2 with the pump submerged and being positioned within the fluid material.

FIG. 4 is a side view in section of the float system in FIG. 3 attached to the conduit.

FIG. 5 is a float member of the float system of FIG. 1 attached to the conduit.

FIG. 6 is a perspective view of a float member of the float system of FIG. 1.

FIG. 7 is a sectional view of the float member of the float system of FIG. 1.

FIG. 8 is a partial sectional view of a float element of the float member of the float system of FIG. 1 adjacent a surface of the conduit.

FIG. 9 is a side elevational view of a second embodiment of a float system with a plurality of float members disposed on a conduit connected to a pump prior to being inserted into a fluid material or other material.

FIG. 10 is a side view in section of the float system in FIG. 9 attached to the conduit.

FIG. 11 is a float member of the float system of FIG. 9 attached to the conduit.

FIG. 12 is a perspective view of a float member of the float system of FIG. 9.

FIG. 13 is a partial sectional view of a float element of the float member of the float system of FIG. 1 adjacent a surface of the conduit.

FIG. 14 is a sectional view of the float member of the float system of FIG. 9.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

In the illustrated embodiments, the conduit C is a flexible hose, such as a slurry hose, used with a dredging apparatus or a harvester. Thus, hereinafter, the conduit C can be referred to as a “hose” or a “flexible hose.” However, the present application is not limited to a flexible hose that carries a liquid or a slurry. As mentioned above, the conduit C can be an electrical conduit or any other tubular body that requires protection from excessive bending or can benefit from a float member 12 or float system 10 as described in the present disclosure.

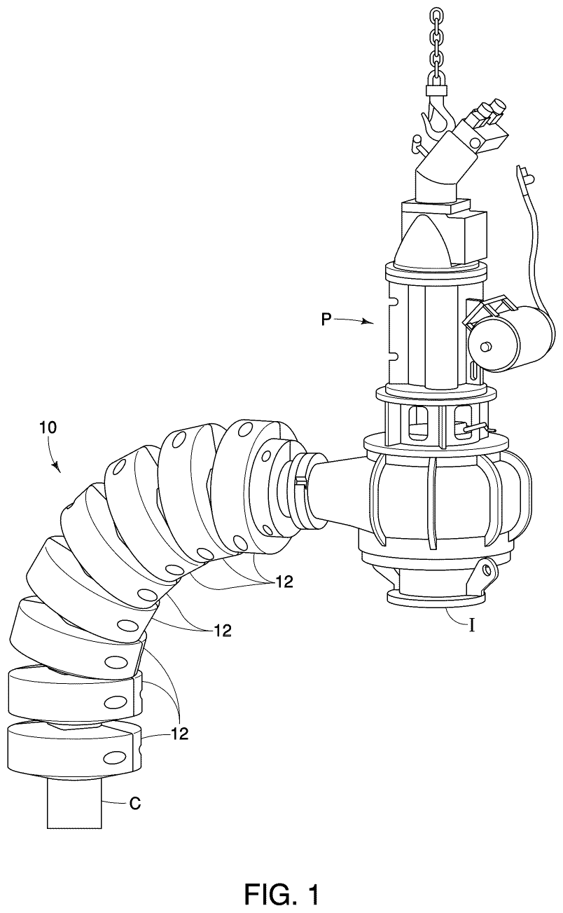

Referring initially to FIGS. 1-4, a float system 10 in accordance with an embodiment of the present disclosure includes a plurality of float members 12. The float members 12 are configured to be attached to the conduit C and provide buoyancy to the conduit C. As can be understood, a pump P can be positioned under the surface of a material M, such as a fluid material F. The pump P can be configured to pump material M from a location, such as at the bottom B, of the fluid material F.

In other words, the pump P is capable of pumping dredged material from the bottom B to a suitable receptacle. As can be understood, the pump P can be used alone or combined with any type of dredge system that dredges material through the inlet I of the pump P and out through the conduit C and onto the hard surface where a reservoir or other suitable container for holding or disposing of the material M is located. The pump P can be any suitable pump. In one embodiment, the pump P can be an Eddy Pump, for example, as described in U.S. Patent Application Ser. No. 16/176,495, filed Oct. 31, 2018, entitled Eddy Pump, now U.S. Pat. No. 10,883,508, the entire contents of which are herein incorporated by reference.

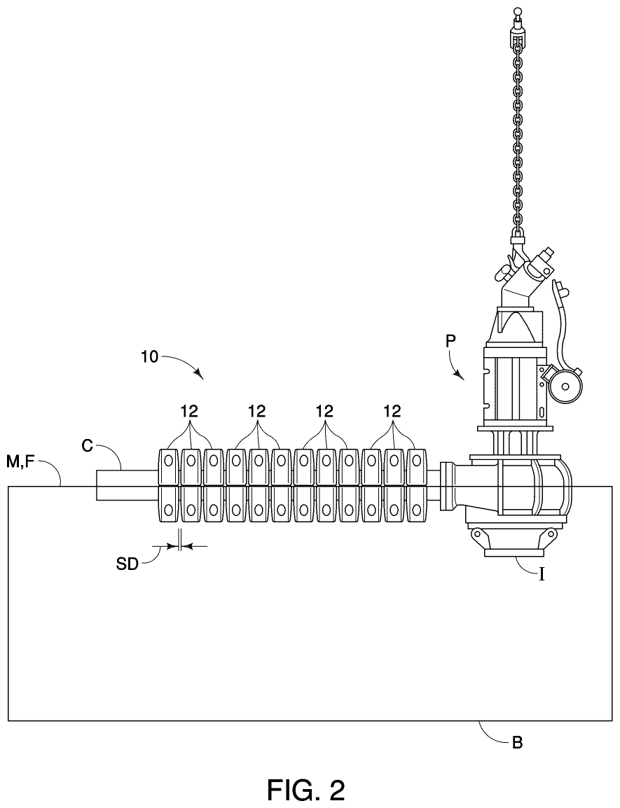

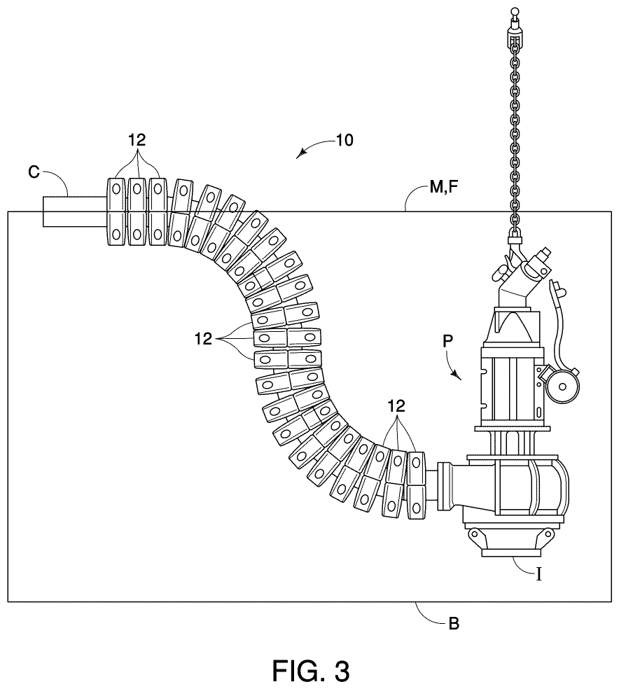

FIGS. 1-3 illustrates the pump P, the conduit C and the float system 10 being inserted into a fluid material F or other material M. FIG. 2 shows the conduit C in a straight configuration while FIGS. 1 and 3 illustrate the conduit C in a bent configuration. As can be understood the configuration and positioning of the plurality of float members 12 in the float system 10 not only provide buoyancy but also restrict the bending angle of the conduit C.

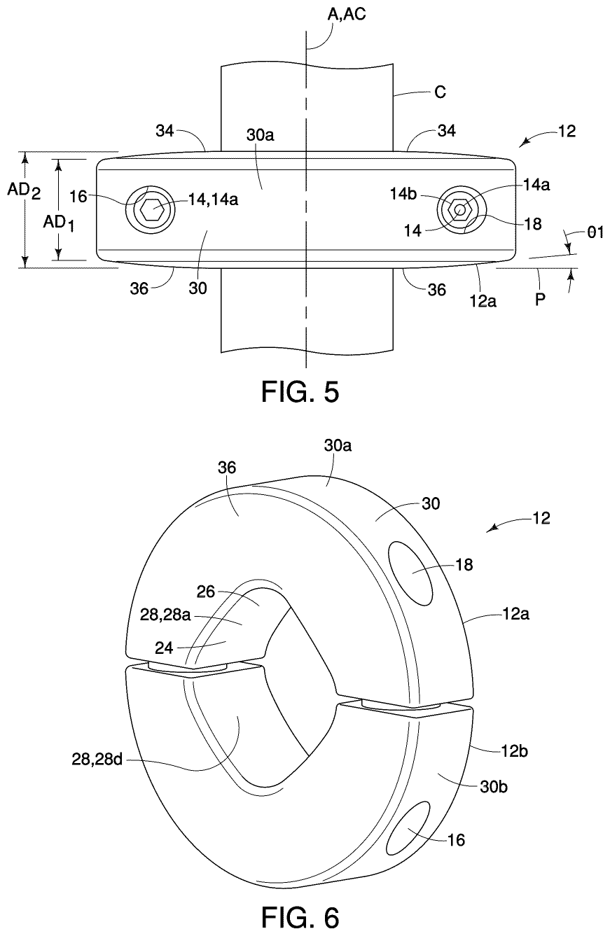

FIGS. 5-8 show a float member 12 in accordance with the float members 12 in FIG. 1-4. Since the float members 12 are generally identical, the description of the float member 12 in FIGS. 5-8 can apply to all of the float members 12 in the float system 10 illustrated in FIGS. 1-4. However, it is noted that while the float system 10 will generally include a plurality of identical or substantially identical float members 12, some of the float members 12 in the float system 10 can have a different structure to the float members 12 disclosed in FIGS. 5-8.

The float member 12 includes a first float element 12a and a second float element 12b that are configured to be attached together to form the float member 12 having a donut-like or tubular shape. In one embodiment the first float element 12a and the second float element 12b can be attached to each other so as to be adjacent. The first and second float elements 12a and 12b are generally made of High Density Polyethylene (HDPE). As can be understood, HDPE enables the floats elements to be a roto-molded. However, it is noted that the float elements 12a and 12b can be formed from any suitable material and in any suitable manner.

In some embodiments, each of the first float element 12a and the second float element 12b can be substantially semicircular such that each of the first float element 12a and the second float element 12b forms approximately one half of the donut-like or tubular shape when the first float element 12a and the second float element 12b are coupled together. The first float element 12a and the second float element 12b can be completely separate elements that are configured to be attached together at opposite sides of the semicircular shape. This configuration enables the float member 12 to be attached to a conduit C at any time. For example, even if the conduit C is already connected between a pump P and a discharge location at a work site, the first float element 12a and the second float element 12b can be arranged on the conduit C and connected together easily at any suitable location along the length of the conduit C. However, it is noted that the first and second float element 12bs can be connected in a manner to enable the conduit C to be inserted into the opening between the first and second float element 12bs and then be coupled in a manner to hold the conduit C therein. Moreover, if desired the float member 12 can be a single unitary (monolithic) structure that is provided to the conduit C by fitting the conduit through the opening in the float member 12.

The float member 12 preferably includes at least one fastener 14 configured to fasten the first float element 12a to the second float element 12b. The fastener 14 can be a bolt, a screw, a clamp or other type of fastener. The fastener 14 can include a bolt 14a and a nut 14b. Preferably the fastener 14 can be easily installed and removed so that the float member 12 can be easily attached to or removed from the conduit C. The first float element 12a can include a first fastener receiving structure 16 for receiving the at least one fastener 14. The second float element 12b can also include a second fastener 18 receiving structure for receiving the at least one fastener 14. In some embodiments, the first fastener 14 receiving structure and the second fastener 14 receiving structure can include a hole or a passage configured to receive a bolt or a screw. One of the first fastener receiving structure 16 and the second fastener receiving structure 18 can include a threaded hole configured to mesh with the bolt 14a or a screw. Alternatively, one of the first fastener receiving structure 16 and the second fastener receiving structure 18 can include a nut holding portion 14c for securely holding the nut 14b having a threaded hole configured to mesh with the bolt or the screw. Alternatively, one of the first fastener receiving structure 16 and the second fastener receiving structure 18 can include a latch or other engaging portion for engaging with a clamp or other type of fastener 14 different from a bolt or a screw.

In some embodiments the float member 12 can be configured to be secured together with two or more fasteners 14. For example, the at least one fastener 14 can include a pair of fasteners 14. Likewise, the first fastener receiving structure can include a pair of first fastener receiving structures 16, and the second fastener receiving structure 18 can include a pair of first fastener receiving structures 18. The pair of first fastener receiving structures 16 and the pair of second fastener receiving structures 18 can be arranged on opposite sides of the first float element 12a and the second float element 12b, respectively, such that the first float element 12a and the second float element 12b can be secured together at two sides (e.g., opposite sides) of the float member 12 with the pair of fastener 14s. With this structure, the first float element 12a and the second float element 12b can be completely separated from each other when the fasteners 14 are removed to facilitate attaching the float system 10 to the conduit C. Meanwhile, the first float element 12a and the second float element 12b can be securely attached to each other with the two fasteners 14 such that the float member 12 is securely fixed to the conduit C when the two fasteners 14 are tightened. Additionally, the clamping force of the first float element 12a and the second float element 12b against the conduit C can be adjusted evenly on both sides of the float member 12 by tightening the two fasteners 14 appropriately.

In one embodiment, the first float element 12a and the second float element 12b are identical and the position relative to each other is merely reversed. Thus, the first fastener receiving structure 16 on the first float element is substantially identical to the first fastener receiving structure 16 on the second float element 12b, and the second fastener receiving structure 18 on the first float element is substantially identical to the second fastener receiving structure 18 on the second float element. However, one of the first and second float elements 12a and 12b can include both first fastener receiving structures 16 and the other of the first and second floor elements 12a and 12b can include both second fastener receiving structure 18. Moreover, it can be understood, the any combination of fastener receiving structures can be disposed on either of the first and second float elements 12a and 12b.

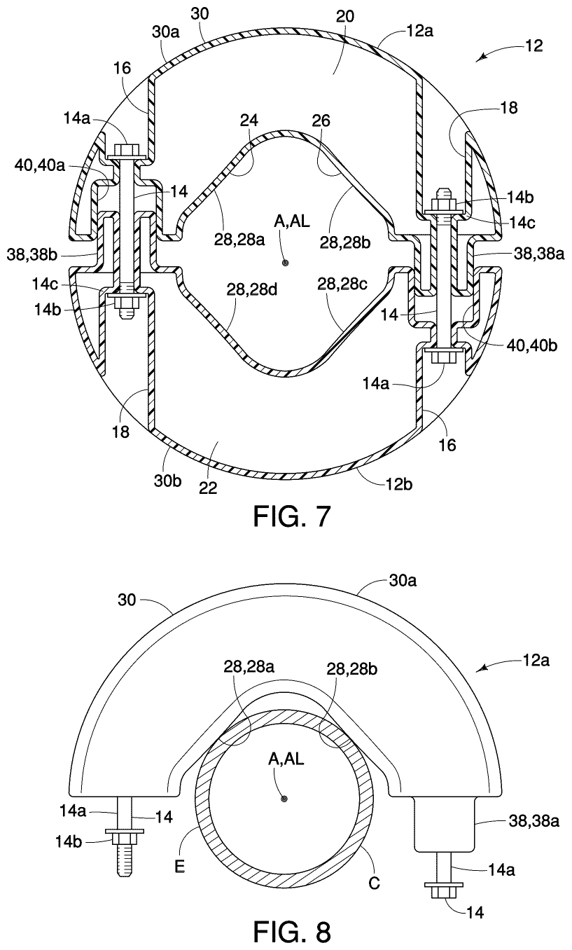

In some embodiments, as illustrated in FIG. 7, the first float element 12a is configured to define a first interior space 20, and the second float element 12b is configured to define a second interior space 22. That is, each of the first float element 12a and second float element 12b is basically a hollow shell having an interior space inside. In some embodiments, the first interior space 20 is filled with air and the second interior space 22 is filled with air. Thus, each of the first float element 12a and the second float element 12b is a hollow shell filled with air to provide buoyancy. Preferably the first interior space 20 and the second interior space 22 are sealed to be airtight and watertight. This structure enables the float system 10 to be manufactured inexpensively using a minimal amount of material while also securing a sufficient degree of strength and buoyancy. The first float element 12a and the second float element 12b are preferably made of a plastic material M having a suitable degree of strength and rigidity, such as HDPE as mentioned above. However, metal or another suitable material can also be used.

In other embodiments, each of the first interior space 20 and the second interior space 22 can be filled with a buoyant material M other than air. The buoyant material M can be a foam plastic or other material M that is lightweight and provides buoyancy. By filling the first interior space 20 and the second interior space 22 with a buoyant material other than air, the float member 12 can be provided with additional strength in comparison with filling the interior spaces with air. For example, if the buoyant material has a degree of rigidity, the float member 12 as a whole can be made more rigid by filling the interior spaces with the buoyant material M. Also, depending on the buoyant material M used, it may not be necessary to manufacture the first float element 12a and the second float element 12b to be airtight and/or watertight because the buoyant material itself can help prevent the intrusion of water into the interior spaces.

As can be understood the first interior space 20 and the second interior space 22 can be filled with different materials, having the same or different buoyancy characteristics. Thus in some embodiments, for example, the second interior space 22 in the second float element 12b can have a higher buoyancy than the first interior space 20 in the first float element 20, such that the float system 10 can cause the conduit C to float with a specific side up and/or down.

Preferably, the first fastener 14 receiving structure is external to the first interior space 20 and the second fastener 14 receiving structure is external to the second interior space 22. In this way, the first fastener 14 receiving structure and the second fastener 14 receiving structure can be prevented from interfering with the first interior space 20 and second interior space 22. When the first interior space 20 and the second interior space 22 are sealed, this configuration can facilitate avoidance of disturbing the sealed state of the first interior space 20 and the second interior space 22.

The first float element 12a and the second float element 12b are configured such that, in the assembled state of the float system 10, the float member 12 has a central opening 24 and an inner circumferential surface 26 defined by the first float element 12a and the second float element 12b. Preferably, the inner circumferential surface 26 includes at least one flat portion 28. When the at least one fastener 14 is tightened, the at least one flat portion 28 serves to grip the exterior surface E of the conduit C more securely than a curved surface that matches the curvature of the conduit C. The at least one flat portion 28 can deform an exterior surface E of the conduit C to a degree such that float system 10 is less likely to rotate around a center axis A of the conduit C. Preferably, the at least one flat portion 28 defines a surface lying in a plane that is substantially parallel to an axial centerline of the float member 12. Configuring the at least one flat portion to be parallel to an axial centerline AC of the float member 12 to ensure that the flat portion 28 will contact the exterior surface E of the conduit C evenly as the at least one fastener 14 is tightened.

Preferably, the at least one flat portion 28 includes a plurality of flat portions 28a-28d (e.g. four flat portions 28a-28d). The plurality of flat portions 28a-28d includes can include two pairs of flat portions. The flat portions of each of the two pairs of flat portions can diametrically opposed and substantially parallel to each other. For example, the flat portion 28a of the first float element 12a and the flat portion 28c of the second float element 12b can be considered a pair of flat portions and the flat portion 28b of the first float element 12a and the flat portion 28d of the second float element 12b can be considered a pair of flat portions. The two pairs of flat portions can be configured such that the central opening 24 has a square shape when viewed along the axial centerline of the float member 12, as seen in FIG. 7. Alternatively, the plurality of flat portions 28a-28d can include three or more pairs of flat portions such that the central opening 24 has a hexagonal shape or an octagonal shape. Also, the inner circumferential surface 26 of the float element is not limited to including a flat portion 28 or a plurality of flat portions 28a-28d. It is also acceptable for the inner circumferential surface 26 to be circular or to have any other suitable shape.

The size of the central opening 24 is adjustable by tightening and loosening the at least one fastener 14. In a preferred embodiment, the float member 12 includes two fasteners 14 arranged on opposite sides of the central opening 24. With this configuration, both the size of the central opening 24 and the clamping force of the float member 12 with respect to the conduit C can be adjusted precisely by tightening and loosening the two fasteners 14.

In addition to the inner circumferential surface 26 and the central opening 24, the float member 12 has an outer circumferential surface 30 defined an outer surface 30a of the first float element 12a and an outer surface 30b of the second float element 12b. Preferably, the float member 12 is configured such that an axial dimension of the float member 12 is a larger at the inner circumferential surface 26 than at the outer circumferential surface, as illustrated in FIG. 5. Configuring the float member 12 to have an axial dimension AD₁ at the outer circumferential surface 30 less than an axial dimension AD: at the inner circumferential surface 26 enables the conduit C to bend to a certain degree even when a plurality of the float members 12 are attached to the conduit C closely adjacent to one another as explained in more detail below. Preferably, the axial end faces 34 and 36 of the float member 12 are configured to taper gradually from the inner circumferential surface 26 to the outer circumferential surface such that a smooth transition from a straight state of the conduit C to a fully bent state of the conduit C can be achieved.

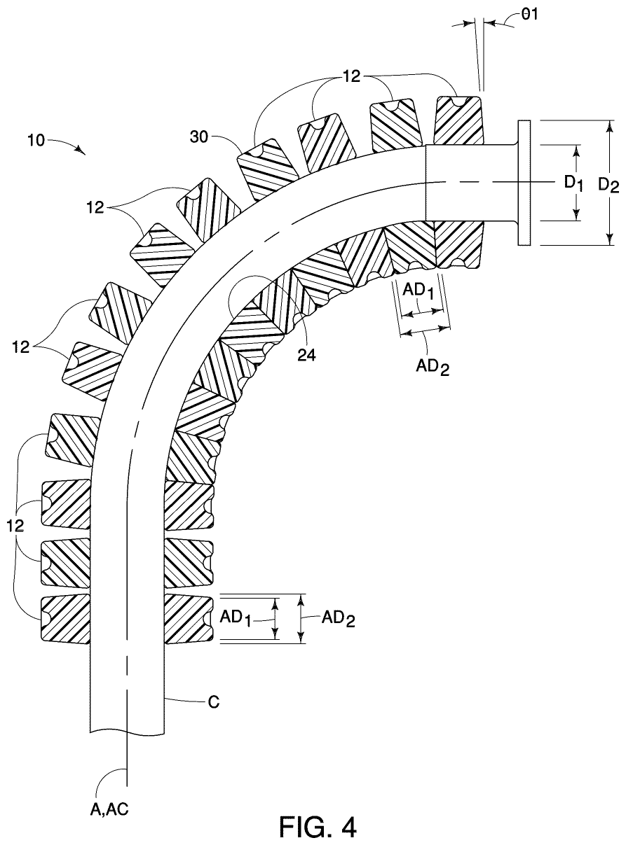

As illustrated in FIGS. 4 and 5, the width of the float member 12 in the longitudinal direction is greatest at the central portion that is disposed adjacent the conduit C. That is, the float member 12 is widest at the central portion and tapers in the radial direction, such that the radial outer circumferential edge of the float member 12 has a width that is less than the width at the central portion. That is, as described above the axial dimension AD₁ at the outer circumferential surface 30 is less than the axial dimension AD: at the inner circumferential surface 26. In one embodiment, the tapering of the sides of the float member 12 results in the side forming an angle θ that can be defined as an angle formed by a radius of the side passing through an axial endpoint of the inner circumferential surface 26 of the float system 10 at the end face with respect to a line that is coincident with the end face in a cross-sectional view. In other words, the taper angle θ indicates a degree to which the end face deviates from a plane P that is perpendicular to the axial centerline AC of the float member 12. Preferably, the taper angle θ is in a range of 3-12 degrees or, more preferably, 5-9 degrees. In the embodiment mentioned above, approximately twelve of the float members limit a 90-degree bend of the flexible conduit C to a 30-inch radius when the float members 12 are spaced apart at the prescribed spacing distance, and each of the float members 12 has a taper angle θ of approximately 6-7 degrees. See for example. FIG. 4.

Preferably, each of the first float element 12a and the second float element 12b includes a guide lug 38 to facilitate positioning the first float element 12a and the second float element 12b with respect to each other. The guide lug 38 of one of the first float element 12a and the second float element 12b can be configured to fit into a guide opening 40 provided on the other of the first float element 12a and the second float element 12b. Preferably, the first float element 12a includes a first guide lug 38a and a first guide opening 40a, and the second float element 12b includes a second guide lug 38b and a second guide opening 40b. The first guide opening 40a is configured to receive the second guide lug 38b and the second guide opening 40b is configured to receive the first guide lug 38a. The first float element 12a and the second float element 12b are assembled by fitting the first guide lug 38a into the second guide opening 40b and fitting the second guide lug 38b into the first guide opening 40a. Afterward, the at least one fastener 14 can be tightened to securely fasten the first float element 12a and the second float element 12b together.

In some embodiments, as shown in FIGS. 7 and 8 the first guide lug 38a and the first guide opening 40a and the second guide lug 38 and the second guide opening can include a pair of second fastener 14 receiving structures. With this configuration, one fastener 14 can be installed through the first guide lug 38a and the second guide opening 40b and another fastener 14 can be installed through the second guide lug 38b and the first guide opening 40a. In this way, the fasteners 14 can be used to adjust the clamping force in a direction parallel to the direction in which the first guide lug 38a and the second guide lug 38b fit into the second guide opening 40b and the first guide opening 40a. This arrangement prevents the fastener 14s from exerting forces in directions that are diagonal, perpendicular, or skew with respect to the insertion direction of the first guide lug 38a and the second guide lug 38b into the second guide opening 40b and the first guide opening 40a.

As can be understood, in one embodiment, one of the first and second float elements 12a and 12b can include both first and second guide luges 38a and 38b and the other of the first and second float elements 12a and 12b can include both of the first and second guide openings 40a and 40b, or any combination thereof.

As discussed herein, the float system 10 is configured to include a plurality of float members 12 arranged adjacent to one another along the longitudinal direction of a conduit C. The plurality of float members 12 function to limit the bending of the conduit C by interacting with one another so as to prevent the conduit C from being bent beyond a prescribed bend radius. The bend radius is determined by a combination of the nominal size of the conduit C, the shape of the float members 12, and the spacing between the float members 12 attached to the conduit C.

The conduit C can be a flexible conduit C having a prescribed nominal diameter D₁. In the case of a slurry hose used with a dredging apparatus or a vegetation harvester, the flexible conduit C typically has a nominal diameter of about six inches. However, the flexible conduit C is not limited to a nominal diameter of six inches and can have any diameter or can have a varying diameter D₁. The nominal diameter D₁ of the flexible conduit C can be four inches, eight inches, or any other diameter or combination of diameters along the length of the conduit C, as appropriate for a particular application. The float members 12 are configured to accommodate the nominal size of the flexible conduit C. That is, the diameter of the central opening 24 of the float member 12 is approximately equal to the nominal size of the conduit C. In the case of a six-inch conduit C, the float member 12 are configured such that the central opening 24 is approximately six inches in diameter. The central opening 24 should be small enough for the first float element 12a and the second float element 12b to clamp down on the outer circumference C of the flexible conduit C when the fasteners 14 of the float members 12 are tightened but large enough not to pinch or damage the flexible conduit C when the fasteners 14 are tightened. Thus, as can be understood, the float members 12 are fixed into position along the longitudinal direction of the conduit C by a friction fit. However, it is noted that the float members 12 can be connected to or affixed to the conduit C in any suitable or desired manner.

In the case of a six-inch conduit C, the float system 10 is configured to limit the bend radius of the flexible conduit C to 30 inches when the float members 12 are attached to the flexible conduit C with a prescribed interval or spacing distance in-between. Preferably, the float members 12 are configured to limit the bend radius of the flexible conduit C to 30 inches when the float members 12 are attached to the flexible conduit C with a prescribed spacing distance SD of 0.25 to 3 inches between adjacent float members. More preferably, the prescribed spacing SD distance is 0.5 to 1.5 inches. With this configuration, the float members 12 are close enough together to protect the flexible conduit C and spaced far enough apart to allow a certain degree of bending of the flexible conduit C. The prescribed spacing SD also allows for easier attachment and detachment of an individual float system 10 without interference from adjacent float members 12. In one embodiment, at least a portion of the float members 12 can be in contact with one another when the conduit C is in a straight configuration, as discussed in more detail below.

In the case of a six-inch flexible conduit C, the float members 12 are preferably configured such that eight to twenty of the float members 12 will limit a 90-degree bend of the flexible conduit C to a 30-inch radius when the float members 12 are spaced apart at the prescribed spacing distance. More preferably, the float members 12 are configured such that ten to sixteen of the float members 12 will limit a 90-degree bend of the flexible conduit C to a 30-inch radius when the float members 12 are spaced apart at the prescribed spacing distance. In one embodiment, approximately twelve of the float members 12 serve to limit a 90-degree bend of the flexible conduit C to a 30-inch radius when the float members 12 are spaced apart at the prescribed spacing distance.

An axial dimension of each of the float members 12 is selected to be sufficient to achieve the required buoyancy to support the flexible conduit C when the flexible conduit C is full of water, slurry, or other material. Preferably, the axial dimension AD: of the float member 12 is approximately 0.5 to 1.5 times the outer diameter D₁ of the flexible conduit C. More preferably, the axial dimension AD: of the float member 12 is smaller than the outer diameter D₁ of the flexible conduit C but larger than one-half the outer diameter D₁ of the flexible conduit C. Meanwhile, an outer diameter D₂ of the float system 10 (e.g., each float member 12) is from 1.5 to 3 times the outer diameter D₁ of the flexible conduit C. More preferably, the outer diameter D₂ of the float system 10 is from 2 to 2.5 times the outer diameter D₁ of the flexible conduit C.

There is no particular limit on the number of float members 12 that are attached to the flexible conduit C to form the float system 10. Any number can be attached as needed. However, the float members 12 can be particularly advantageous to use at portions of the flexible conduit C where the flexible conduit C is connected to a pump P or other equipment or any location where the conduit C must be bent in order to route the flexible conduit C to where it needs to be connected or arranged, as illustrated in FIGS. 1-3.

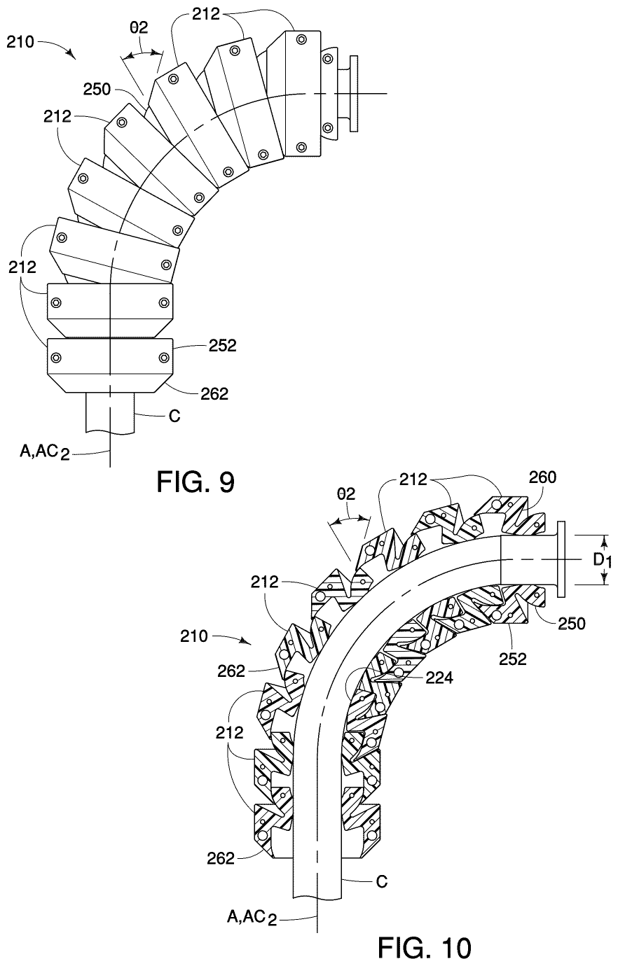

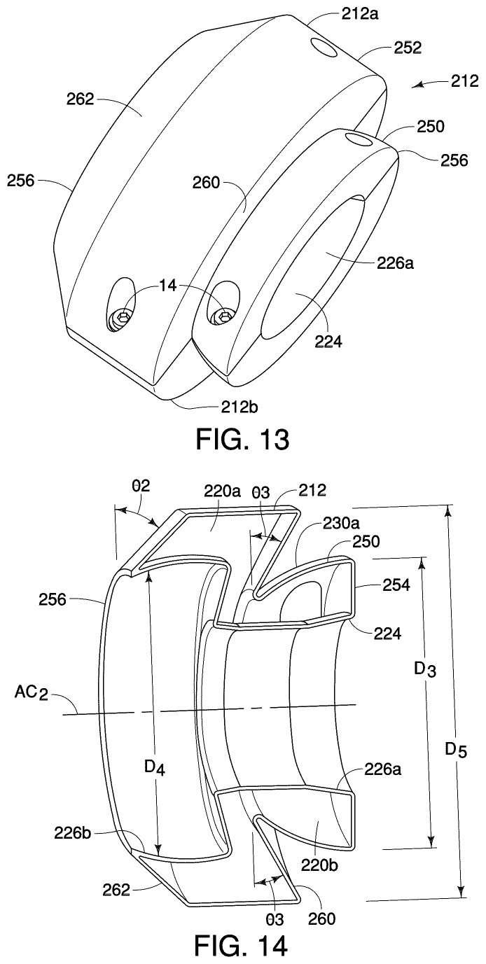

FIGS. 9-14 illustrated a second embodiment of a float system 210 of the present disclosure. In this embodiment, the float system 210 includes a plurality of float members 212. The float members 12 are configured to be linked or connected together rather than being spaced apart by a prescribed distance. Like the embodiment discussed above, each of the float members 12 includes a first float element 212a and a second float element 212b, the first float element 212a and the second float element 212b being configured to be attached together to form a float member 212 having a donut-like shape. In this embodiment, the float member 212 of the float system 210 includes a first end 254 and a second end 256 spaced apart from the first end 254 in an axial direction. The float member 212 further includes a first section 250 that includes the first end 254 and a second section 252 that includes the second end 256. An outer diameter D₃ of the first section 250 is smaller than an inner diameter D₄ of the second section 252. The outer circumferential surface 230a of the first section 250 has a tapered shape that narrows from the first end toward 254 the second end 256. The inner circumferential surface 226b of the second section 252 has a tapered shape that narrows toward the second end 256. Each of the float members 212 is configured such that the outer circumferential surface 230a of the first section 250 of one of the float members 212 can fit inside the inner circumferential surface 226b of the second section 252 of another one of the float members 212 to form the float system 212. See for example. FIGS. 9 and 10. Preferably, the shape of the outer circumferential surface 230a of the first section 250 is substantially the same as a shape of the inner circumferential surface 226b of the second section 252 in a cross-sectional view that includes an axial centerline AC₂ of the float member 212. The size the outer circumferential surface 230a of the first section can be slightly smaller than the inner circumferential surface 226b of the second section 252 so that the outer circumferential surface 230a of the first section 250 of the one of the float members 212 can fit readily inside the inner circumferential surface 226b of the second section 252 of the other one of the float members 212.

The first section 250 and the second section 252 are configured such that the one of the float members 12 can rotate and pivot with respect to the adjacent other of the float members 12 when the float members 12 are linked together. The outer circumferential surface 230a of the first section 250 and the inner circumferential surface 226a of the second section 252 can be configured to have complimentary shapes that enables the outer circumferential surface 226a of the first section 250 and the inner circumferential surface 226a of the second section 252 to slide smoothly with respect to each other when the flexible conduit C bends. Preferably, the outer circumferential surface 230a of the first section 252 and the inner circumferential surface 226a of the second section 252 have a curved shape such that the first section 250 fits inside the second section 252 and forms a ball-and-socket type joint.

Preferably, the float members 212 of the this embodiment are configured such that they limit bending of the flexible conduit C to a prescribed bend radius when the float members 212 are attached to the flexible conduit C and linked together by enclosing the first section 250 of each of the float members 212 inside the second section 252 of an adjacent one of the float members 212. Preferably the plurality of float members 212 of the this embodiment function to limit the bending of the conduit C by interfering with one another so as to prevent the conduit C from being bent beyond a prescribed bend radius. The bend radius is determined by a combination of the nominal diameter D₁ of the conduit C and the shape of the float members 212. In this embodiment, the float members 212 are not spaced apart because they are linked together with the first section 250 of each of the float members 212 disposed inside the second section 252 of an adjacent one of the float members 212 attached to the conduit C.

As mentioned above, each of the float members 212 according to this embodiment includes a first section 250 and a second section 252. The second section 252 has a larger inner diameter D₄ than the outer diameter D₃ of the first section 250, and the outer circumferential surface 230a of the first section 250 and the inner circumferential surface 226b of the second section 252 are configured to have complimentary shapes such that the first section of one of the float members 212 can be accommodated inside the second section 252 of another of the float members 12. This configuration enables the float members 212 to bend and rotate with respect to one another while linked together.

Each of the interior areas 220a and 220b of the first section 250 and a second section 252 can include a buoyant material. For example, the interior areas 220a and 220b of the first section 250 and a second section 252 can be filled with air or other suitable gas. Alternatively, the interior areas 220a and 220b of the first section 250 and a second section 252 can be filled with a buoyant material other than air. Thus, the float member 212 can be provided with additional strength in comparison with filling the interior spaces with air. For example, if the buoyant material has a degree of rigidity, the float member 212 as a whole can be made more rigid by filling the interior spaces with the buoyant material. Also, depending on the buoyant material used, it may not be necessary to manufacture the first float element 212a and the second float element 212b to be airtight and/or watertight because the buoyant material itself can help prevent the intrusion of water into the interior areas 220a and 220b.

Additionally, the second section 252 of each of the float members 12 includes a first wall 260 surface and a second wall surface 262. The first wall surface 262 faces toward the first section 250 in the axial direction, and the second wall surface 262 is disposed at the second end 256 of the float element and faces away from the first section 252 in the axial direction. The first wall surface 260 and the second wall surface 262 are configured to limit the bend radius of the flexible conduit C by interference of the first wall surface 262 of one of the float members 12 with respect to the second wall surface 262 of an adjacent one of the float members 12 when the float members 12 are linked together. See for example. FIGS. 9 and 10.

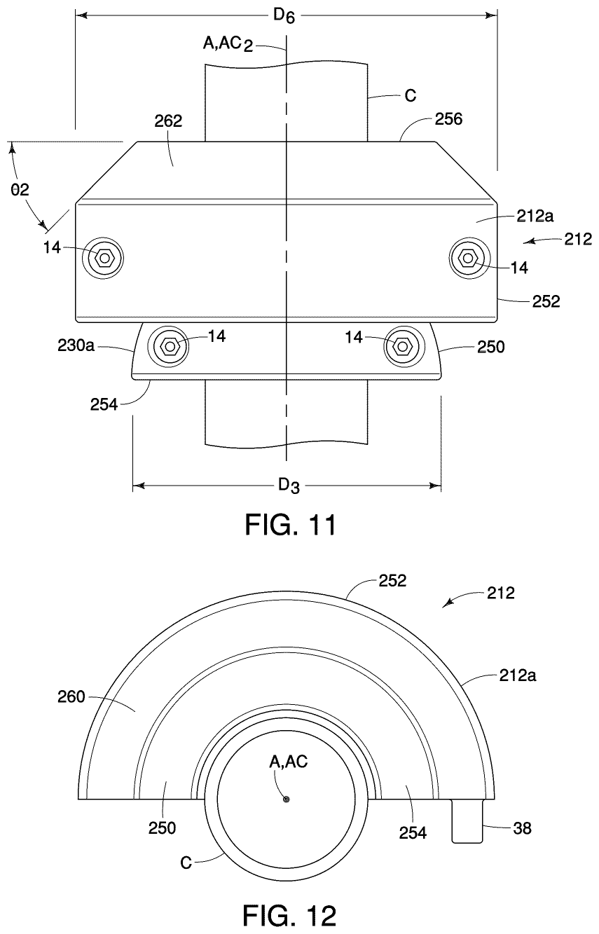

Specifically, as shown in FIGS. 11 and 14, each of the first wall surface 260 and the second wall surface 262 is a substantially cone-shaped surface. The first wall surface 260 leans toward the outer circumferential surface 230a of the first section 250 in a cross-sectional view that includes the axial centerline AC: of the float member 212. Thus, the first wall surface 260 has the form of an internal cone surface. Meanwhile, the second wall surface 262 has the form of an external cone surface that tapers to a narrower diameter toward the second end 256 of the float member 256. The taper angle θ; of the first wall surface 260 is smaller than the taper angle θ2 of the second wall surface 262. That is, the first wall surface 260 makes a smaller angle with respect to a plane that is perpendicular to the axial centerline AC₂ of the float member 212, and the second wall surface 262 makes a larger angle with respect to the same plane. Thus, in the cross-sectional view, the first wall surface 260 appears steeper than the second wall surface 262 with respect to the axial centerline AC₂. When the float members 212 are linked together on the flexible conduit C, the difference between the taper angle θ; of the first wall surface 260 and the taper angle θ2 of second wall surface 262 allows for a certain degree of bending before the first wall surface 260 of one of the float members 212 interferes with the second wall surface 262 of an adjacent one of the float members 212. Once the first wall surface 260 of the one of the float members 212 and the second wall surface 262 of the adjacent one of the float members 212 interfere with each other, further bending of the flexible conduit C is prevented.

The taper angles of the first wall surface 260 and the second wall surface 262 can be adjusted to achieve the desired bend radius of the flexible conduit C. In some embodiments, the taper angle θ; of the first wall surface 260 can be in a range of 15 to 35 degrees and the taper angle θ2 of the second wall surface 262 can be in the range of 30 to 60 degrees. Preferably, the taper angle θ3 of the first wall surface 260 is in the range of 20 to 30 degrees and the taper angle θ2 of the second wall surface 262 is in the range of 40 to 50 degrees. In one embodiment, the taper angle θ3 of the first wall surface 260 is approximately 27 degrees and the taper angle θ2 of the second wall surface 262 is approximately 45 degrees.

In the case of a six-inch conduit C, the float members 212 of the alternative embodiment are configured to limit the bend radius of the flexible conduit C to 30 inches when the float members 212 are attached to the flexible conduit C and linked together as explained above. In the case of a six-inch flexible conduit C, the float members 212 of the alternative embodiment are preferably configured and dimensioned such that four to twelve of the float members 212 will limit a 90-degree bend of the flexible conduit C to a 30-inch radius when the float members 212 are attached to the conduit C and linked together. More preferably, the float members 212 are configured and dimensioned such that six to ten of the float members 212 will limit a 90-degree bend of the flexible conduit C to a 30-inch radius when the float members 212 are attached to the conduit C and linked together. In one embodiment, approximately eight of the float members 212 limit a 90-degree bend of the flexible conduit C to a 30-inch radius when the float members 212 are attached to the conduit C and linked together.

With this embodiment, the float members 212 completely cover the flexible conduit C because the float members 212 are linked together. Consequently, no portion of the flexible conduit C is exposed where the float members 212 are installed. This embodiment is also advantageous in that it is not necessary for a person installing the float members 212 to be concerned with the spacing between the float members 212. Instead, the interlocking structure of the float members 212 ensures proper positioning of the float members 212 with respect to one another.

In the alterative embodiment, the first float element 212a and the second float element 212b of each of the float members 212 can be fastened together using fasteners 14 in a similar manner to the previous embodiment. The first float element 212a and the second float element 212b can be configured such that each forms substantially one half of the donut-like shape of the float member 212. Preferably at least two fasteners 14 are used to fasten the first float element 212a and the second float element 212b. In some embodiments, four fasteners 14 can be used with two of the fasteners 14 being installed with respect to the first section 250 of the float member 212 and the other two of the fasteners 14 being installed with respect to the second section 252 of the float member 212. However, any configuration of fasteners 14 can be used so long as the first float element 212a and the second float element 212b can be securely fastened together and securely fixed to the flexible conduit C.

Similarly to the previous embodiment, an inner circumferential surface 226a of the first section 250 can include least one flat portion to improve the gripping strength of the float system 210 with respect to the flexible conduit C. The at least one flat portion can include a plurality of flat portions. For example, the plurality of flat portions includes can include two pairs of flat portions in the same manner as described above for the first embodiment. The flat portions of each of the two pairs of flat portions can diametrically opposed and substantially parallel to each other. The two pairs of flat portions can be configured such that the central opening 224 has a square shape when viewed along the axial centerline AC₂ of the float member 212. Alternatively, the plurality of flat portions can include three or more pairs of flat portions such that the central opening 224 has a hexagonal shape or an octagonal shape. Also, the inner circumferential surface 226a of the float member 212 is not limited to including a flat portion. It is also acceptable for the inner circumferential surface 226a to be circular or to have any other suitable shape.

In the illustrated embodiments described above, the float system 212 is used with a flexible conduit C, such as a slurry conduit C of a dredging apparatus or a harvester. However, the present disclosure is not limited to a flexible conduit C that carries a liquid or a slurry. As mentioned above, the conduit C can be an electrical conduit C or any other tubular body that requires protection from unacceptable or excessive bending.

The description of the fathers 14 and the lug 38 in the first embodiment is applicable to the second embodiment. Moreover, as with the first embodiment (float member 12), the first element 212a and the second element 212b of the float member 212 can be the same or mirror images of each other and formed from the same materials and in the same manner as the first embodiment (float member 12). As description of the first embodiment (float system 10 and/or float member 12) that is not explicitly modified in the second embodiment (float system 210 and/or float member 212) can be applicable to the second embodiment (float system 210 and/or float member 212).

The embodiments of a float system as described herein provide a simple light-weight structure that enables a flexible conduit to float on a water surface while preventing the conduit from bending excessively. This feature is particularly useful at portions of the conduit where the conduit is connected to a pump or other apparatus and can be prone to excessive bending. The float members also serve to protect the conduit from rocks and other objects onshore or in shallow water. In this way, expensive conduits, such as slurry hoses used with dredgers and harvesters, can be protected while enabling material to be pumped through the hose efficiently without flow restrictions. In addition to being used on flexible hoses carrying liquids or slurries, floats according to the present disclosure can also be used with electrical conduits, flexible tubes or hoses carrying gases or any other material, or any other tubular conduit that is at risk of bending beyond an acceptable bend radius. Moreover, since the float members are capable of being used in a float system that includes a plurality of float members arranged adjacent one another along the outer surface of the conduit, the float members can be used selectively along portions of the conduit where they are most needed. Thus, the float members can provide a cost-effective way to protect the conduit at the portions where protection is needed the most.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “element” or “element” when used in the singular can have the dual meaning of a single part or a plurality of parts. Also as used herein to describe the above embodiment(s), directional terms refer to those directions of a float system configured to be mounted to a conduit. Accordingly, these terms, as utilized to describe the present invention should be interpreted relative to the harvester.

The term “configured” as used herein to describe a component, section or part of a device or element includes hardware and/or software that is constructed and/or programmed to carry out the desired function.

The terms of degree such as “generally”, “substantially”, “about” and “approximately” as used herein mean a reasonable amount of deviation of the modified term such that the end result is not significantly changed.

While only selected embodiments have been chosen to illustrate the present invention, it will be apparent to chosen skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A float system for a conduit, the float system comprising:
a first float element configured to attach to the conduit; and
a second float element configured to attach to the conduit adjacent the first float element,
the first float element and the second float element configured to restrict a bending angle of the conduit.

2. The bend float system according to claim 1, further comprising:
at least one fastener configured to fasten the first float element to the second float element.

3. The float system according to claim 2, wherein
when attached, the first float element and the second float define a central opening, and the at least one fastener is configured to be capable of adjusting a size of the central opening by tightening and loosening the at least one fastener.

4. The float system according to claim 1, wherein
the first float element is configured to define a first interior space, and
the second float element is configured to define a second interior space.

5. The float system according to claim 4, wherein
the first interior space is filled with air, and
the second interior space is filled with air.

6. The float system according to claim 4, wherein
the first interior space is filled with a buoyant material, and
the second interior space is filled with the buoyant material.

7. The float system according to claim 6, wherein
the buoyant material is a foam plastic.

8. The float system according to claim 1, wherein
the first float element includes a first engagement surface that extends transverse to a longitudinal direction of the conduit, when the first float element is attached to the conduit, the first engagement surface configured to form an angle with a plane that is perpendicular to a longitudinal direction of the conduit.

9. A float system for a conduit, comprising:
a first float member configured to attach to the conduit; and
a second float member configured to attach to the conduit adjacent the first float member,
the first and second float members configured to interact to prevent a reduction of flow through the conduit.

10. The float system according to claim 9, wherein
a portion of the first float member is configured to contact a portion of the second float member to prevent the reduction of flow through the conduit.

11. The float system according to claim 9, wherein
the first and second float members have adjustable connection surfaces.

12. The float system according to claim 9, wherein
the first and second float members are configured to prevent a substantial reduction in an internal area of the conduit.

13. The float system according to claim 9, wherein
the first float member includes a first engagement surface that extends transverse to a longitudinal direction of the conduit, when the first float member is attached to the conduit, and the second float member includes a second engagement surface that extends transverse to the longitudinal direction of the conduit, when the second float member is attached to the conduit, the first and second engagement surfaces configured to be separate when the conduit is straight and configured to engage when the conduit is in a curved configuration.

14. A float system for a conduit, the float system comprising:
a plurality of float members, each float of the plurality of float members including a first float element and a second float element, the first float element and the second float element being configured to be attached together,
the plurality of float members being attachable to the conduit so as to be spaced apart by a prescribed distance and configured to limit bending of the conduit to a prescribed bend radius.

15. The float system according to claim 14, wherein the plurality of float members includes a first float member and a second float member, and a portion of the first float member is configured to contact a portion of the second float member to limit bending of the conduit to the prescribed bend radius.

16. The float system according to claim 15, wherein
the first float member includes a first engagement surface that extends transverse to a longitudinal direction of the conduit, when the first float member is attached to the conduit, and the second float member includes a second engagement surface that extends transverse to the longitudinal direction of the conduit, when the second float member is attached to the conduit, the first and second engagement surfaces configured to be separate when the conduit is straight and configured to engage when the conduit is in a curved configuration.

17. The float system according to claim 15, wherein
each of the float members of the plurality of members has adjustable connection surfaces.

18. The float system according to claim 14, wherein
the plurality of float members are configured to prevent a substantial reduction in an internal area of the conduit.

19. A float system according to claim 14, wherein
the first float member is configured to interlock with the second float member.

20. A float system according to claim 14, wherein
each of the first and second float members includes a first section and a second portion, and the first and second float members being configured to connect together by having the second portion of the first float member being accommodated within the first section of the second float member.
